(19) United States
(12) Patent Application Publication
(10) Pub. No.: US 2013/0192950 A1
(43) Pub. Date: Aug. 1, 2013

(54) Raised bearing surface clutch friction plate machine

(71) Applicants: Gary Neale Warren, Washington, MO (US); Robert Aldine Black, Greensboro, GA (US); Richard Eugene Finley, China Spring, TX (US)

(72) Inventors: Gary Neale Warren, Washington, MO (US); Robert Aldine Black, Greensboro, GA (US); Richard Eugene Finley, China Spring, TX (US)

(73) Assignee: Rabco, Inc., Conyers, GA (US)

(21) Appl. No.: 13/385,032

(22) Filed: Jan. 30, 2012

(51) Int. Cl. F16D 13/66; F16D 13/64

(52) U.S. Cl. 192/107 C; 192/107 R

(57) ABSTRACT

A Clutch Friction Plate Machine which has a friction plate with elevated plates or annular rings bonded to the clutch friction plate bearing surface. The elevated plates or annular rings may be of different materials, and some of the elevated plates or annular rings may be raised by spring means so that the one or more spring means raised elevated plates or annular rings engage with the opposing bearing surface first and then pressure causes the one or more spring means raised elevated plates or annular ring surfaces to lower allowing subsequent bearing surface engagement with the one or more nonspring means raised elevated plates or annular ring surfaces.

### TECHNICAL FIELD OF THE INVENTION

This invention is made for the purpose of more smoothly, effectively, and efficiently transmitting torque through a clutch. This invention has applications in the automobile and mechanical machine industry and in every machine where torque is transmitted through a clutch system or when a clutch system is used to brake or stop rotational motion such as a brake system.

### BACKGROUND—PRIOR ART

Clutches are machines used to transfer rotational force or torque and are commonly used in cars to transfer the rotational force and energy from the engine to the driveshaft and wheels. In cars, clutches are normally part of the transmission, Clutches are used in innumerable machines other than cars such as machines featuring electric engines or wherever rotational force is being transmitted.

The simplest clutches have two clutch friction plates, each in the shape of a disk, with one disk connected to the engine and rotating and the other disk connected to the driveshaft with means to separate or disconnect the two clutch disks. When connected, the two clutch friction plates are pressed together with each of the clutch friction plate flat round sides pressed together so that each plates axis of rotation is on the same line. A small number of clutch friction plates are in the shape of a cone.

The portion of a clutch friction plate which presses up against or touches the other clutch friction plate is the bearing surface.

When the clutch friction plates bearing surfaces, are pressed together, frequently one clutch friction plate is rotating at a different angular velocity than the opposing clutch friction plate. As the clutch friction plates press together, normally lightly or slightly at first, and normally with more force as time passes, the plates may slide until the angular velocities of the clutch friction plates are the same. The friction between the clutch plate bearing surfaces transmits torque from one clutch plate to another and causes the clutch friction plates to, under most circumstances, to reach the same angular velocity. Normally, in a clutch machine, you want the clutch friction plates, when in contact with another clutch friction plate to achieve the same angular velocity. If the clutch plates are in contact but not at the same angular velocity several bad things occur:
1. The clutch friction plates slip and rub and wear off the bearing surface from friction;
2. The clutch friction plates slip, rub, and create heat from friction;
3. While rubbing or slipping the clutch friction plates may shudder and “grab” and “release”; and,
4. Since under most circumstances static friction is greater that kinetic friction, while slipping the clutch friction plates transmit less torque than when not slipping and some of the energy is converted into heat from friction.

Prior art is to have the clutch friction plate bearing surface the same material as the rest of the clutch plate. Some clutch friction plates have used a surface coating on the bearing surface of a material different than that of the clutch friction plate itself. One surface material will have advantages and disadvantages over the useful range of performance of a clutch friction plate. Some materials offer smooth operation during the sliding phase, when the clutch friction plates are sliding and do not have the same angular velocity. Some materials may perform poorly when the clutch friction plates are sliding but provide good performance and lockup once the clutch friction plates have stopped sliding and have the same angular velocity. A device called a “marcel tab” was sometimes used to suspend the entire friction plate to stop chattering. However, marcel tabs were not used in conjunction with annular rings or plates set atop a clutch friction plate nor were marcel tabs used to allow differential engagement of the annular rings or plates upon a clutch friction plate. Prior art was limited to one material without differential engagement of the clutch friction plate bearing surface and the resulting design and performance compromises.

U.S. Pat. No. 7,984,894 to Chauza describes a clutch system for winches. Chauza does not teach nor mention any particular clutch friction plate configuration.

U.S. Pat. No. 7,975,817 to Mueller et al. describes a torque converter with a multiple disk clutch. Mueller does not teach nor mention any raised annular rings or plates on the clutch friction plate bearing surface, any different materials comprising separate portions of thebearing surface, nor does Mueller teach or mention any spring means to raise one or more annular rings or one or more plates located on the clutch friction plate bearing surface.

U.S. Pat. No. 7,993,235 to Wittkopp et al. describes a transmission with planetary gears. Wittkopp does not teach nor mention any particular clutch friction plate configuration.

U.S. Pat. No. 7,992,696 to Mahlberg describes a transmission system for construction machinery with a clutch. Mahlberg does not teach nor mention any particular clutch friction plate configuration.

U.S. Pat. No. 7,992,697 to Vatin et al. describes a complicated friction face system with multiple layers of faces and friction linings with multiple interacting tongues. Vatin does not teach the simplicity and effectiveness of one or more annular rings or plates of different materials, bonded to the clutch friction plate bearing surface with spring means to raise one or more raised annular rings or plates. Vatin does not teach nor mention the use of multiple plates or multiple annular rings of different materials on the clutch friction plate bearing surface. Instead Vatin describes a complicated means to connect opposing friction faces in a clutch but not the face of a clutch friction plate bearing surface.

U.S. Pat. No. 7,984,801 to Hirayanagi et al. describes a clutch friction plate with spline tooths and a system of oil grooves. Hirayanagi does not teach nor mention elevated plates or annular rings of different materials on the clutch friction plate bearing surface nor does Hirayanagi teach or mention spring means raised annular rings or plates on the clutch friction plate bearing surface.

U.S. Pat. No. 7,980,375 to Suzuki el al. describes a system of oil grooves on a clutch friction plate. Suzuki does not teach nor mention elevated plates or annular rings of different materials on the clutch friction plate bearing surface nor does Suzuki teach or mention spring means raised annular rings or plates on the clutch friction plate bearing surface.

U.S. Pat. No. 7,980,376 to Nakano et al describes a method of preconditioning the surface of a wet paper friction plate. Nakano does not teach nor mention a design for a clutch friction plate bearing surface.

U.S. Pat. No. 7,988,597 to Lee et al. describes a method for controlling a torque converter clutch. Lee does not teach nor mention a design for a clutch friction plate bearing surface.

U.S. Pat. No. 7,980,989 to Oswald et al. describes a double clutch transmission. Oswald does not teach nor mention a design for a clutch friction plate bearing surface.

U.S. Pat. No. 7,984,800 to Frey et al. describes a hydrodynamic clutch system: Frey does not teach nor mention elevated plates or annular rings of different materials on the clutch friction plate bearing surface nor does Hirayanagi teach or mention spring means raised annular rings or plates on the clutch friction plate bearing surface.

U.S. Pat. No. 7,971,697 to Kemmner et al. describes a system for hydraulic control of a clutch. Kemmner does not teach nor mention elevated plates or annular rings of different materials on the clutch friction plate bearing surface nor does Kemmner teach or mention spring means raised annular rings or plates on the clutch friction plate bearing surface.

U.S. Pat. No. 7,979,186 to Fayyad et al. describes a clutch slip rate monitoring system. Fayyad does not teach nor mention a design for a clutch friction plate bearing surface.

U.S. Pat. No. 7,979,187 to Osselaere et al. describes a system of controlling the bearing pressure of a clutch system. Osselaere does not teach nor mention a design for a clutch friction plate bearing surface.

### Advantages of the Claimed Invention

However, the present invention first allows different materials to meet and allows different materials to be used on the bearing surface. This allows the use of materials which engage smoothly while sliding and upon lockup and also materials which may be more effective after lockup. In addition, the present invention allows different materials to come into contact at different times in the clutch engagement process. Materials which work well during the sliding period can engage first and then materials which work best when the clutch plates have matched angular velocities can then engage.

This clutch friction plate invention consists of three aspects which are new to the art and science of clutch friction plates.

First, unlike prior art of clutch friction plates, the invention features one or more raised annular rings bonded to the clutch friction plate bearing surface. The one or more raised annular rings may be of a same or different material than the rest of the clutch friction plate. The opposing clutch friction plate may also have one or more raised annular rings, and the opposing clutch friction plate raised annular rings do not have to overlap or interact with each other. The raised annular ring(s) allow the performance of the clutch friction plate to be “tuned”. One annular ring could be composed of a compound which is very good for ultimate locked up performance but poor, because it may result in slippage or shuddering or vibration during the time the opposing clutch friction plates are slipping and not fully engaged. Another annular ring could be composed of another compound which operates without shuddering or vibration during the period the opposing clutch friction plates are slipping.

Second, unlike prior art of clutch friction plates, raising one or more annular rings with spring means, allows further “tuning” of the clutch friction plate system and allows one or more annular rings to engage first and then other annular rings or the clutch friction plate bearing surface to engage later when their materials are most effective. A clutch can be smooth during the sliding period yet strong when the clutch friction plates have matched angular velocities.

Third, the spring means raised portions of the clutch friction plate do not have to be shaped in an annular ring but may be raised plates of any shape. This allows tuning of the clutch friction plate bearing surface through materials of the plates, different raised heights of the plates, different positions of the plates, and different shapes of the plates.

Therefore, this invention allows clutch friction plate bearing surfaces of multiple materials, engaging at different times, with different shapes. All the foregoing factors can be selected by the designer for a smooth, strong, and effective clutch friction plate system for whatever parameters the designer wants for his clutch friction plate system.

### SUMMARY OF THE CLAIMED INVENTION

First, the raised bearing surface clutch friction plate machine may features one or more raised annular rings bonded to the clutch friction plate bearing surface. Second, the raised bearing surface clutch friction plate machine may feature raised annular rings spring means elevated to allow engagement with the opposing clutch friction plate bearing surface at different times during the clutch engagement process. Third, the raised bearing surface clutch friction plate machine may feature spring means elevated plates not in the shape of annular rings but of any shape.

### DRAWINGS

FIG. 1 is a plan view of a first embodiment.

FIG. 2 is a side view of a first embodiment.

FIG. 3 is an exploded view of a first embodiment.

FIG. 4 is a plan view of a second embodiment.

FIG. 5 is a side view of a second embodiment.

FIG. 6 is an exploded view of a second embodiment.

FIG. 7 is a side view of the strip member used in the second and third embodiments.

FIG. 8 is a plan view of the strip member used in the second and third embodiments.

FIG. 9 is a plan view of a third embodiment.

FIG. 10 is a side view of a third embodiment.

FIG. 11 is an exploded view of a third embodiment.

### LIST OF REFERENCE NUMERALS

102—clutch friction plate

104—annular ring

106—rivet

108—pilot hole

110—heat slots

112—spring holes

114—shoulder rivet holes

502—strip member

802—rivet hole

902—raised plate

### DETAILED DESCRIPTION

For all three embodiments shown, a standard clutch friction plate made of heat treated cold rolled steel with an approximate thickness of 1/16th of an inch, with heat slots cut radially into the disk for cooling, and with six spring holes and shoulder rivet holes for mounting the hub, springs and retaining plate. The hub, springs, and retaining plate used for all three embodiments are standard in the industry and are not shown on the drawings.

For the first and second embodiments, the annular rings have a width of approximately ⅞ of an inch and a thickness of approximately 1/16 of an inch. For the first and second embodiments, the outer annular ring is a ferramic material and the inner annular ring is a kevlar based material.

For the second and third embodiments, the strip member is composed of heat treated 1018 steel.

The second embodiment is used with a clutch friction disk with a diameter greater than 8 & ⅞ inches.

The third embodiment is used with a clutch friction disk with a diameter equal to or less than 8 & ⅞ inches. The raised plates of the third embodiment are each approximately 1/16 of an inch thick, in a rough trapezoidal shape with approximately one half of the plates being spring means elevated plates composed of a kevlar based material with the nonspring means elevated plates being composed of ferramic material.

### First Embodiment

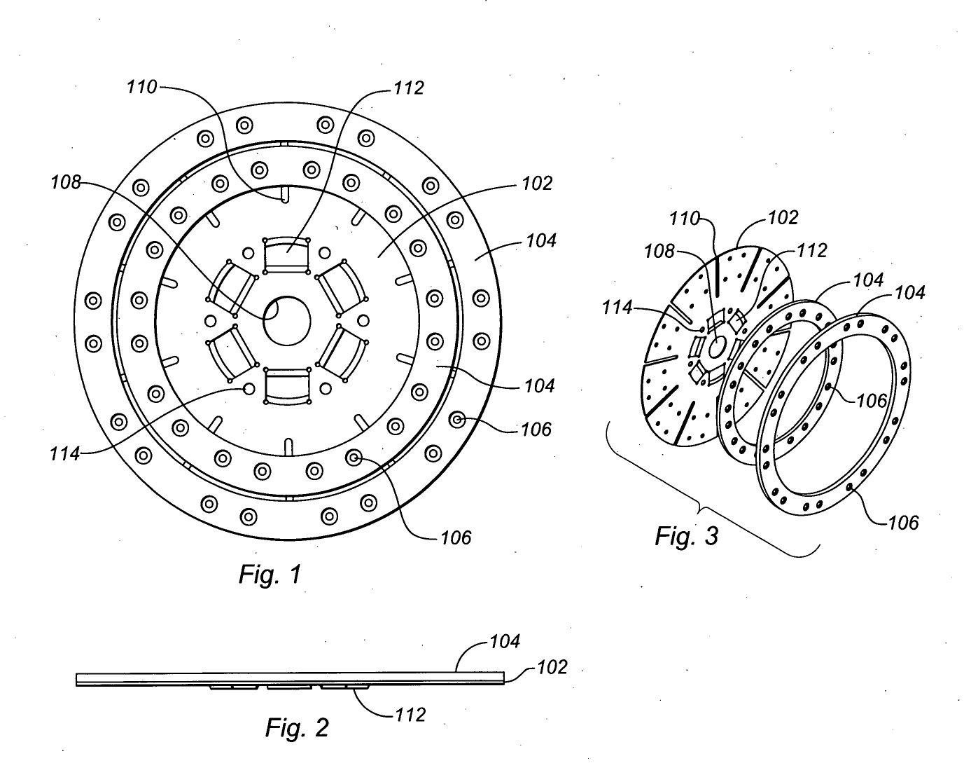

FIG. 1 shows a plan view of the first embodiment of the clutch friction plate invention. The clutch friction plate invention has a core plate (102). On the bearing surface of the core plate (102) is bonded two elevated annular rings (104) radiused from the friction plate axis of rotation. The two elevated annular rings (104) are bonded to the core plate (102) with rivets (106). One of the elevated annular rings (104) is of a ferrous material and the second elevated annular ring (104) is composed of an organic or carbon material.

FIG. 2 shows a side view of the first embodiment of the clutch friction plate invention. The clutch friction plate has a core plate (102). On the bearing surface of the core plate (102) is bonded two elevated annular rings (104) radiused from the friction plate axis of rotation. The two elevated annular rings (104) are bonded to the core plate (102) with rivets (106). One of the elevated annular rings (104) is of a ferrous material and the second elevated annular ring (104) is composed of an organic or carbon material.

FIG. 3 shows an exploded view of the first embodiment of the clutch friction plate invention. The clutch friction plate has a core plate (102). On the bearing surface of the core plate (102) is bonded two elevated annular rings (104) radiused from the friction plate axis of rotation. The two elevated annular rings (104) are bonded to the core plate (102) with rivets (106). One of the elevated annular rings (104) is of a ferrous material and the second elevated annular ring (104) is composed of an organic or carbon material.

The first embodiment has an outer annular ring of ferramic or iron based material, and an inner annular ring composed of a kevlar based material.

### Second Embodiment

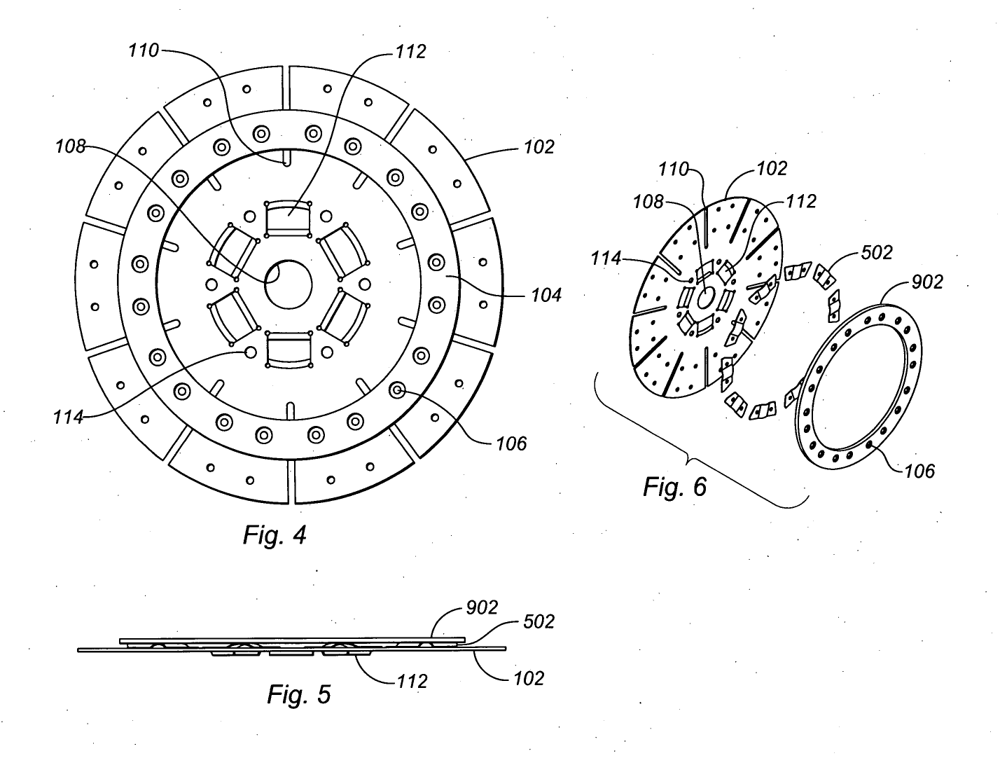

FIG. 4 shows a plan view of the second embodiment of the clutch friction plate invention. The clutch friction plate invention has a core plate (102). On the bearing surface of the core plate (102) are bonded two elevated annular rings (104) radiused from the friction plate axis of rotation. The first elevated annular ring (104) is bonded to the core plate (102) with rivets (106). The second elevated annular ring (104) is bonded to the core plate with rivets with strip members (502), bent so that the strip members surface does not lie in one plane, placed between the second elevated annular ring (104) and the core plate (102). The strip members (502) are attached to the rivets (106). One of the elevated annular rings (104) is of a ferrous material and the second elevated annular ring (104) is composed of an organic or carbon based material.

FIG. 5 shows a side view of the second embodiment of the clutch friction plate invention. The clutch friction plate invention has a core plate (102). On the bearing surface of the core plate (102) are bonded two elevated annular rings (104) radiused from the friction plate axis of rotation. The first elevated annular ring (104) is bonded to the core plate (102) with rivets (106). The second elevated annular ring (104) is bonded to the core plate with rivets with strip members (502), bent so that the strip members surface does not lie in one plane, placed between the second elevated annular ring (104) and the core plate (102). The strip members (502) are attached to the rivets (106). One of the elevated annular rings (104) is of a ferrous material and the second elevated annular ring (104) is composed of an organic or carbon based material.

FIG. 6 shows a exploded view of the second embodiment of the clutch friction plate invention. The clutch friction plate invention has a core plate (102). On the bearing surface of the core plate (102) are bonded two elevated annular rings (104) radiused from the friction plate axis of rotation. The first elevated annular ring (104) is bonded to the core plate (102) with rivets (106). The second elevated annular ring (104) is bonded to the core plate with rivets with strip members (502), bent so that the strip members surface does not lie in one plane, placed between the second elevated annular ring (104) and the core plate (102). The strip members (502) are attached to the rivets (106). One of the elevated annular rings (104) is of a ferrous material and the second elevated annular ring (104) is composed of an organic or carbon based material.

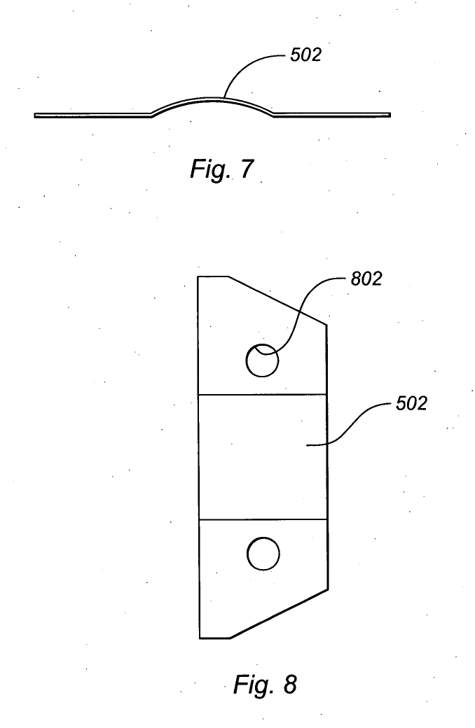

FIG. 7 shows a side view of the strip member (502) used in the second and third embodiments of the clutch friction plate invention. The strip member (502) is bent in the middle in the shape of an arch so that the strip member surface does not lie in one plane.

FIG. 8 shows a plan view of the strip member (502) used in the second and third embodiments. The strip member (502) is bent in the middle in the shape of an arch so that the strip member surface does not lie in one plane. The strip member (502) has a rivet hole (802) in each end.

The second embodiment has an outer annular ring of ferramic or iron based material, and an inner annular ring made of a kevlar based material.

### Third Embodiment

FIG. 7 shows a side view of the strip member (502) used in the second and third embodiments of the clutch friction plate invention. The strip member (502) is bent in the middle in the shape of an arch so that the strip member surface does not lie in one plane.

FIG. 8 shows a plan view of the strip member (502) used in the second and third embodiment. The strip member (502) is bent in the middle in the shape of an arch so that the strip member surface does not lie in one plane. The strip member (502) has a rivet hole (802) in each end.

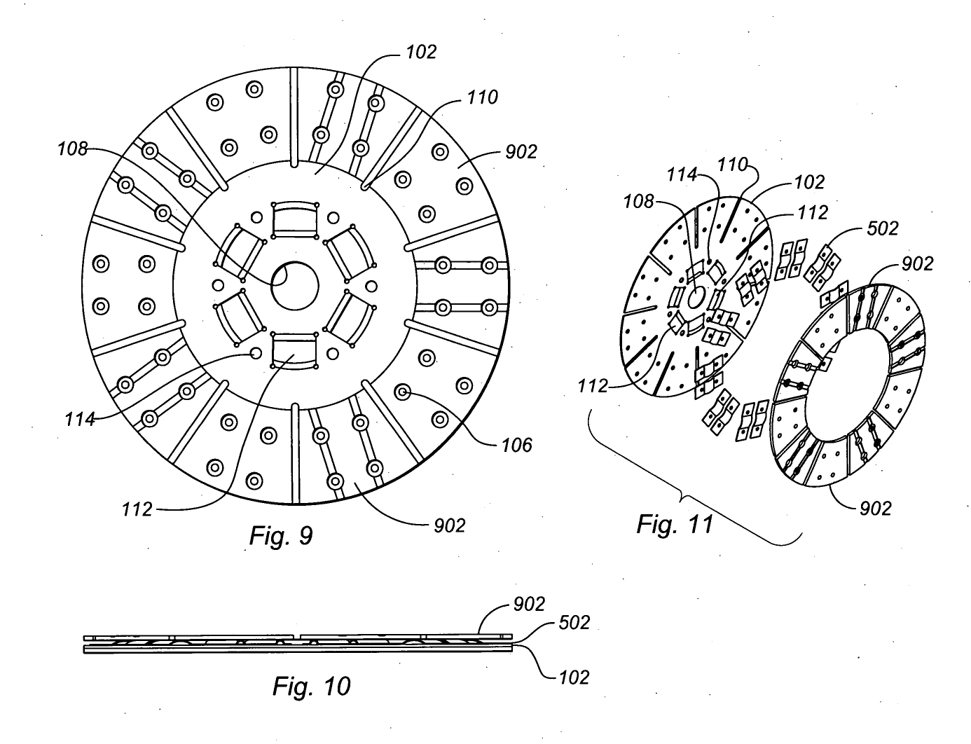

FIG. 9 shows a plan view of the third embodiment of the clutch friction plate invention. The clutch friction plate invention has a core plate (102). On the bearing surface of the core plate (102) are bonded multiple raised plates (902). The multiple raised plates (902) are bonded to the core plate (102) with rivets (106). Some of the raised plates are elevated with two strip members (502), bent so that the strip members surface does not lie in one plane, placed between the some of the raised plates (902) and the core plate (102). The strip members (502) are attached to the rivets (106). The raised plates (902) are of two materials. Some of the raised plates (902) are of a ferrous material and the remainder of the raised plates (902) are composed of an organic or carbon based material.

FIG. 10 shows a plan view of the third embodiment of the clutch friction plate invention. The clutch friction plate invention has a core plate (102). On the bearing surface of the core plate (102) are bonded multiple raised plates (902). The multiple raised plates (902) are bonded to the core plate (102) with rivets (106). Some of the raised plates are elevated with two strip members (502), bent so that the strip members surface does not lie in one plane, placed between the some of the raised plates (902) and the core plate (102). The strip members (502) are attached to the rivets (106). The raised plates (902) are of two materials. Some of the raised plates (902) are of a ferrous material and the remainder of the raised plates (902) are composed of an organic or carbon based material.

FIG. 11 shows a plan view of the third embodiment of the clutch friction plate invention. The clutch friction plate invention has a core plate (102). On the bearing surface of the core plate (102) are bonded multiple raised plates (902). The multiple raised plates (902) are bonded to the core plate (102) with rivets (106). Some of the raised plates are elevated with two strip members (502), bent so that the strip members surface does not lie in one plane, placed between the some of the raised plates (902) and the core plate (102). The strip members (502) are attached to the rivets (106). The raised plates (902) are of two materials. Some of the raised plates (902) are of a ferrous material and the remainder of the raised plates (902) are composed of an organic or carbon based material.

### Conclusion Ramification and Scope

Thus the reader can see that at least one embodiment of the Raised Bearing Surface Clutch Friction Plate Machine:
A. provides and allows a smoother operating clutch friction plate which can be tuned or varied for different applications and operating conditions;
B. allows different materials than that of the body of the clutch friction plate to be used on raised annular rings and plates allowing smoother engagement of the clutch friction plate;
C. allows multiple annular rings or plates, of different dimensions and of different materials, to compose the engagement surface; and,
D. allows through spring means, for various plates and annular rings, to be elevated above and engage at different times in the engagement process resulting in a smoother operating clutch friction plate.

The non spring means elevated annular rings or plates may be bonded to the clutch friction plate by mechanical means such as rivets or screws, by glues or adhesives, or even by chemical bonds such as welding, by shaping or machining the clutch friction plate surface itself, or by depositing material on the clutch friction plate surface.

Although the descriptions given above and in the specifications contain many specifics, these should not be construed as limiting the scope of the invention but as merely providing examples and illustrations of some of the several embodiments of the invention. For example, the Raised Bearing Surface Clutch Friction Plate Machine can be used in clutches and in brakes and wherever torgue is being transmitted, the spring means can be springs, bent strip members, or flexible materials, and the raised plates may be of any shape. Thus the scope of the invention, should be determined by the appended claims and their legal equivalents, rather than by the examples given in the specifications.

1. A clutch friction plate, said friction plate comprising a core plate on which the friction plate bearing surface has one or more elevated annular rings, radiused from the friction plate axis of rotation, and bonded to the friction plate circular surface.

2. The clutch friction plate as claimed in claim 1, in which the friction plate bearing surface has two elevated annular rings with one annular ring of one material and the other annular ring of a different material.

3. The clutch friction plate as claimed in claim 1, with spring means to elevate one or more annular rings above the one or more nonspring means elevated annular rings on the bearing surface so that the one or more spring means elevated annular rings engage with the opposing bearing surface first before the one or more nonspring means elevated annular rings on the clutch friction plate engage with the opposing bearing surface and then pressure normal to the one or more spring means elevated annular ring surfaces causes the one or more spring means elevated annular ring surfaces to lower allowing subsequent bearing surface engagement with the one or more nonspring means elevated annular ring surfaces.

4. The clutch friction plate as claimed in claim 2, with spring means to elevate one annular ring above the nonspring means elevated annular ring on the bearing surface so that the spring mean elevated annular ring engages with the opposing bearing surface first before the nonspring means elevated annular ring on the clutch friction plate engages with the opposing bearing surface, and then pressure normal to the spring means elevated annular ring surface causes the spring means elevated annular ring to lower allowing subsequent bearing surface engagement with the clutch friction plate nonspring means elevated annular ring surface.

5. The clutch friction plate as claimed in claim 1, with springs placed between the friction plate circular surface and one elevated annular ring.

6. The clutch friction plate as claimed in claim 1, with springs placed between the friction plate circular surface and one or more elevated annular rings.

7. The clutch friction plate as claimed in claim 2, with springs placed between the friction plate circular surface and one elevated annular ring.

8. The clutch friction plate as claimed in claim 1, with strip members, with a portion of the strip members bent so that the strip members surface does not lie in one plane, placed between the friction plate circular surface and one or more elevated annular rings.

9. The clutch friction plate as claimed in claim 2, with strip members, with a portion of the strip members bent so that the strip surface does not lie in one plane, placed between the friction plate circular surface and one elevated annular ring.

10. The clutch friction plate as claimed in claim 3, with springs comprising the spring means.

11. The clutch friction plate as claimed in claim 3, with strip members, with a portion of the strip members bent so that the strip members surface does not lie in one plane, comprising the spring means.

12. The clutch friction plate as claimed in claim 4, with springs comprising the spring means.

13. The clutch friction plate as claimed in claim 4, with strip members, with a portion of the strip members bent so that the strip members surface does not lie in one plane, comprising the spring means.

14. The clutch friction plate as claimed in claim 3, with an elastic material, positioned between one or more elevated annular rings and the friction plate, comprising the spring means.

15. The clutch friction plate as claimed in claim 3, with a flexible material, positioned between one or more elevated annular rings and the friction plate, comprising the spring means.

16. The clutch friction plate as claimed in claim 4, with an elastic material, positioned between the elevated annular ring and the friction plate, comprising the spring means.

17. The clutch friction plate as claimed in claim 4, with a flexible material, positioned between the elevated annular ring and the friction plate, comprising the spring means.

18. A clutch friction plate, said friction plate in the shape of a cone in which the friction plate bearing surface has one or more elevated annular rings radiused from the friction plate axis of rotation and bonded to the friction plate cone outer surface.

19. A clutch friction plate, said friction plate in the shape of a cone in which the friction plate bearing surface has one or more elevated annular rings radiused from the friction plate axis of rotation and bonded to the friction plate cone inner surface.

20. The clutch friction plate as claimed in claim 18, with spring means to raise one or more annular rings above one or more annular rings on the bearing surface so that the one or more spring means raised annular rings engage with the opposing bearing surface first before the one or more nonraised annular rings on the clutch friction plate engage with the opposing bearing surface and then pressure normal to the one or more spring means raised annular ring surface causes the one or more spring means raised annular ring surfaces to lower allowing subsequent bearing surface engagement with the one or more clutch friction plate nonspring means raised annular ring surfaces.

21. The clutch friction plate as claimed in claim 21, with spring means to raise one annular ring above the other annular rings on the bearing surface so that the spring mean raised annular ring engages with the opposing bearing surface first before the other annular rings on the clutch friction plate engage with the opposing bearing surface and then pressure normal to the spring means raised annular ring surface causes the spring means raised annular ring surface to lower allowing subsequent bearing surface engagement with the clutch friction plate nonspring means raised annular ring surfaces.

22. A clutch friction plate, in which the plate bearing surface consists of the flat circular side of a disk with raised plate members attached to the flat side of the disk.

23. The clutch friction plate as claimed in claim 24, with spring means to elevate one or more raised plates members above the other raised plate members on the bearing surface so that the spring means elevated raised plate members engage with the opposing bearing surface first before other raised plate members on the bearing surface engage with the opposing bearing surface and then pressure normal to the raised plate members surface causes the spring means elevated raised plate members to lower allowing bearing surface engagement with the nonspring means elevated raised plate members.

24. The clutch plate system machine as claimed in claim 25, with springs comprising the spring means.

25. The clutch plate system machine as claimed in claim 25, with strip members with a portion of the strip members bent so that the strip members surface does not lie in one plane, comprising the spring means.

26. The clutch plate system machine as claimed in claim 25, with an elastic material fastened between the annular ring and the friction plate, comprising the spring means.

27. The clutch plate system machine as claimed in claim 25, with a flexible material fastened between the annular ring and the friction plate, comprising the spring means.

28. The clutch plate system machine as claimed in claim 25, with springs placed between the disk surface and one or more raised plates.
